(19) United States
(12) Patent Application Publication
(10) Pub. No.: US 2009/0292763 A1
(43) Pub. Date: Nov. 26, 2009

(54) THIN CLIENT-SERVER ARCHITECTURE NETWORKS AND USING METHOD THEREOF

(75) Inventors: Chih-Wei CHEN, Taipei City (TW); Hsiao-Fen Lu, Taipei City (TW)

Correspondence Address: Chih Feng Yeh;BRIAN M. MCINNIS, 12th Floor, Ruttonjee House, 11 Duddell Street, Hong Kong, HK

(73) Assignee: INVENTEC CORPORATION

(21) Appl. No.: 12/181,707

(22) Filed: Jul. 29, 2008

(30) Foreign Application Priority Data
May 22, 2008 (TW) 97118937

(51) Int. Cl. G06F 15/16

(52) U.S. Cl. 709/203

(57) ABSTRACT

Thin client-server architecture networks have many servers and at least one thin client. Each server has a hard disk for storing environmental parameters and a synchronizing application having information of the environmental parameters. The thin client connects one of the servers through Internet and has synchronizing module for setting transport protocol with the synchronizing application, receiving the information of the environmental parameters and part of the environmental parameters. The thin client may set the environment of a user interface thereof according to the part of the environmental parameters.

### RELATED APPLICATIONS

This application claims priority to Taiwan Application Serial Number 97118937, filed May 22, 2008, which is herein incorporated by reference.

### BACKGROUND

1. Field of Invention

The present invention relates to the network system. More particularly, the present invention relates to the thin client-server architecture networks.

2. Description of Related Art

During the evolution of modern computers, business-calculating systems changed from mainframe architectures to client-server architecture networks, and to server-based computing architecture networks. The computer industry developed many different kinds of terminals for the server-based computing architecture networks, such as rich client, thin client, smart client, and hybrid client etc.

The thin client-server architecture networks depend primarily on the server for processing activities, and mainly focus on conveying input and output between the user and the server. The thin client is a device designed to provide limited functions, which are useful for user interface programs. Ideally, the thin client may have only a display, an input device like a keyboard, a small capacity memory module like flash memory, and a processor with enough processing power to handle the display and communications.

The thin client is generally cheaper because it does not contain a hard disk, application memory, or a powerful processor. Also, maintenance costs and IT administration costs are low because the thin client can be managed almost entirely over the server.

Often the thin client has embedded firmware to set the environment of the user interface. As we know, different users may prefer different environments requiring different environment configurations. For example, Chinese would like to use the user interface with a Chinese environment, which requires Chinese font data, Chinese input methods, and Chinese keyboard mapping. Since the capacity of the memory module of the thin client is designed to be small, it is not possible for the thin client to contain all environment configurations for different kinds of environment to meet everyone's needs.

Therefore, a new thin client-server architecture network and a using method thereof are needed to allow the thin client to have many different environments without increasing the capacity of the memory module thereof.

### SUMMARY

A thin client-server architecture network is provided. The capacity of the memory module of the thin client may be lowered by changing the location of the data and using data exchanging property between the thin client and the server. The thin client-server architecture network comprises servers and at least one thin client. Each server has a hard disk to store environmental parameters, wherein the environmental parameters stored on the server are different from those stored on other servers. The server further comprises a synchronizing application with the environmental parameters stored in the hard disk on the server.

The thin client consists essentially of a display, a memory module, an input module, a central processing unit, a synchronizing module, and a user interface electrically connected together. The thin client connects one of the servers through the Internet. The synchronizing module sets the transport protocol with the synchronizing application, receives the environmental parameters from the synchronizing application, and receives part of the environmental parameters from the connected server. Afterward, the thin client may change the environment of the user interface thereof according to the received environmental parameters.

In the foregoing, the environmental parameters, which are needed to set the environment of the user interface, are stored in the hard disk on the server and not on the memory module in the thin client. The capacity of the hard disk is large enough to store many environmental parameters for different kinds of environments. The thin client only has to ask the server to download some environmental parameters.

The invention also provides a method for using thin client-server architecture networks. By changing the location where the environmental parameters are stored and using the data exchanging property of the thin client-server architecture networks, the thin client may be deemed as having many different environments without increasing the size of the memory module thereof.

The first step of the using method for the thin client-server architecture networks is to connect a thin client to a server through the Internet, wherein the server has a plurality of environmental parameters stored therein. Then, the thin client sets the transport protocol with the server and receives one of the environmental parameters from the server. Finally, the thin client changes the environment of a user interface thereof according to the received environmental parameter. As the above, all the environmental parameters the user interface needs are stored on the server, not the thin client. Therefore, the size of memory may be smaller.

On the other hand, the invention discloses a method for using thin client-server architecture networks. Using the advantage of information transportation between a thin client and a server to lower the dependency on the memory module of the thin client.

First, an environment of a user interface of the thin client is set as a first environment configuration. Then, the thin client connects to a server through the Internet, wherein the server has a plurality of environmental parameters. After connecting, the thin client sets transport protocol with the server, and receives part of the environmental parameters from it. The thin client uses the received environmental parameters to form a second environment configuration. Therefore, the thin client now has two environment configurations for a user to choose from. When the user chooses the second environment configuration, the thin client may change the environment of the user interface from the first environment configuration to the second environment configuration.

In the foregoing, when setting the environment of the user interface, the user may command the thin client to download the required environmental parameters from the server, such that the capacity of the memory module of the thin client can be smaller.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a thin client-server architecture network according to one embodiment of this invention; and

FIG. 2 is a flow chart of a using method for thin client-server architecture networks according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

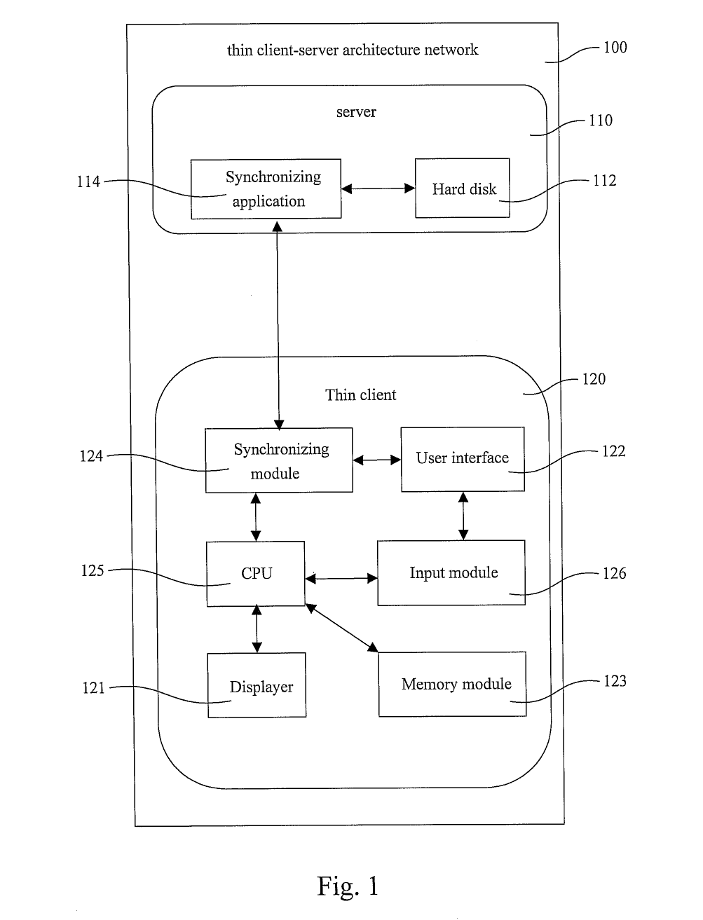

Please refer to FIG. 1. FIG. 1 is a block diagram of a thin client-server architecture network 100 according to one embodiment of this invention. The thin client-server architecture network 100 is a network system comprising many servers 110 and many thin clients 120. Please notice that FIG. 1 only shows one thin client 120 and one server 110 though, the number of servers and thin clients is not limited.

Each server 110 comprises a large capacity hard disk 112 and a powerful processor. The hard disk 112 stores many environmental parameters for different environments. Each server 110 of the thin client-server architecture network 100 contains environmental parameters for one identical environment different from other servers 110, which means the environmental parameters stored in the hard disk 112 in one server 110 are different from those stored in the hard disk 112 in other servers 110. The server 110 comprises a synchronizing application 114 operated for setting transport protocol with the thin client 120. The synchronizing application 114 contains information about the environmental parameters stored in the hard disk 112 on the server 110.

The thin client 120 connects one of the servers 120 through the Internet. In general, the thin client 120 transmits the user's command signal to the server 110, receives the respond signal calculated by the server 110, and displays the respond signal. Therefore, comparing to the server 110, the thin client 120 is designed just enough to provide limited functions mentioned above. In the embodiment of this invention, the thin client 120 consists essentially of a display 121, a user interface 122 for the user operating, a memory module 123 with small capacity, a synchronizing module 124, a central processing unit 125, and an input module 126, wherein all elements are electrically connected together. The synchronizing module 124 sets the transport protocol with the synchronizing application 114 of the connected server 110 to receive the information of the environmental parameters and part of the environmental parameters. Afterward, the thin client 120 may change the environment of the user interface 122 thereof according to the received part of the environmental parameters.

In other words, when the user would like to change the environment of the user interface 122 of the thin client 120, the user must do the following steps. First, the user may connect the thin client 120 to the server 110 through the Internet. The thin client 120 may then set transport protocol with the connected server 110. Specifically, the synchronizing module 124 of the thin client 120 and the synchronizing application 114 of the connected server 110 may communicate and set transport protocol with each other. Meanwhile, the synchronizing module 124 may receive the information of the environmental parameters to learn what the server 110 can offer.

Afterward, the thin client 120 may receive some environmental parameters from the server 110. More specifically, the thin client 120 may only request some particular environmental parameters depending on the needs of the new user interface 122, which the user asks for, and transmit the request as a command signal based on the transport protocol to the server 110. In addition, the thin client 120 may transmit a command signal to the server 110 according to the user's order.

The server 110 may respond to the command signal from the thin client 120 and send back the environmental parameters. In the embodiment of this invention, the server 110 has a program operated for selecting at least one environmental parameter from the hard disk 112 according to the command signal, and transmitting the selected environmental parameter to the thin client 120. After receiving the selected environmental parameter, a new user interface 122 can be formed based on the received environmental parameter.

The environment of the user interface 122 refers to all configurations for the user to operate the thin client 120 conveniently and comfortably. For example, the environment of the user interface 122 may be a Chinese language environment containing the environmental configurations for Chinese language such as Chinese font data, input methods and keyboard mapping method for Chinese language. In the embodiment of this invention, the environmental parameters may be font data, font characters and the character coding thereof, character coding of an input method, and/or keyboard encoding of keyboard mapping.

It is obvious that different environments need different environmental parameters. However, the capacity of the memory module 123 of the thin client 120 is too small to contain all environmental parameters for the user to choose from.

In the embodiment of this invention, the environmental parameters are stored in the hard disk 112 on the server 110. More specifically, the hard disk 112 in each server 110 in the thin client-server architecture network 100 stores at least one environmental parameter different from those stored on the other server 110. Therefore, the thin client 120 may connect the server 110, which has the environmental parameters that the user wants, and get some environmental parameters from the server to establish the environment of the user interface 122, instead of increasing the capacity of the memory module 123 to store large amounts of environmental parameters therein.

Take the language environment as an example. The server 110 may contain environmental parameters for setting a first language like Chinese. The thin client 120 may connect the server through the Internet to receive some environmental parameters, and use the received environmental parameters to set the environment of the user interface 122 as a first language environment. In detail, the server 110 has the environmental parameters of the first language such as font data, input methods, and/or keyboard mapping of the first language. On the other hand, the thin client 120 may contain the environmental parameters of a second language like English or Japanese, different from the first language. The thin client 120 may have font data, input methods, and/or keyboard mapping of the second language. The user may use the method mentioned above to transmit part of the environmental parameters of the first language from the server 110 to the thin client 120, form the first language environment in the thin client 120, and change the language environment of the user interface 122 from the second language to the first language. As the above, the thin client-server architecture network 100 has many servers 110, wherein each server 110 has different environmental parameters for different languages. The thin client 120 may connect different servers 110 to set different language environments.

In the foregoing, the thin client 120 may have one language environment, or even no language environment. When the user wants to operate the thin client 120 or to change the environment of the user interface 122, thin client 120 may receive the needed environmental parameters from the server 110 to set the language environment thereof, such that the space of the memory module 123 may be release.

In addition, the thin client 120 may receive one or few environmental parameters from the server 110. For example, the server 110 may include a program like an input method and environmental parameters like font characters of many different font types and character coding according to the font characters. The program like an input method may calculate the command signal from the thin client 120 to choose a font type, to use the character coding finding out the corresponding font character, and furthermore, to transmit the font character to the thin client 120. The thin client 120 may remain the second language environment and have the font character of the first language. Therefore, it is not necessary for the thin client 120 to store font characters of all kind of font types and the character coding of those font characters.

Furthermore, the server 110 may has a program operated as keyboard mapping, for example keyboard mapping for Chinese phonetics or keyboard mapping for Cangjie input method, which is based on the graphical aspect of the Chinese font characters. By operating the thin client 120 with the above method, the thin client 120 may offer the user many different keyboard mapping to use even it may not has any environmental parameters for keyboard mapping stored therein.

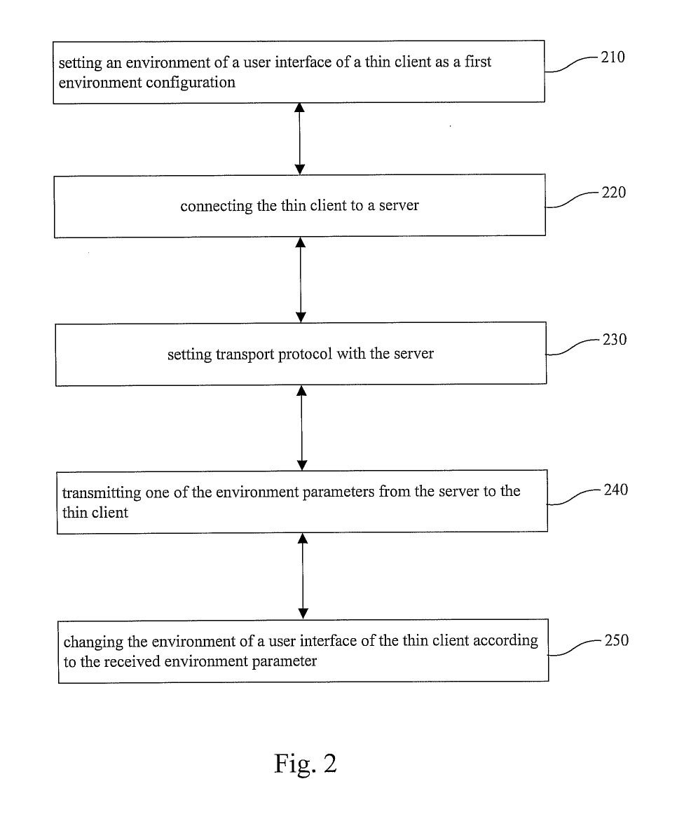

Please refer to FIG. 2. FIG. 2 is a flow chart of a using method 200 for thin client-server architecture networks according to another embodiment of this invention. The using method 200 has several steps described as follows. First, in step 210, the environment of the user interface of the thin client is set as a first environment configuration. The thin client uses the environmental parameters stored therein to establish the first environment configuration. In step 220, the thin client connects to the server through the Internet, wherein the server has environmental parameters different from those stored in the thin client. In step 230, the thin client sets the transport protocol with the connected server to set up the rules and parameters for communication. And then, in step 240, part of the environmental parameters are transmitted from the server to the thin client receives. This means the thin client downloads at least one environmental parameter from the server based on the transport protocol.

In the final step 250, the thin client changes the environment of the user interface thereof according to the received environmental parameters. Specifically, the thin client uses the received environmental parameters to form a second environmental configuration and changes the environment of the user interface from the first environment configuration to the second environment configuration.

In the foregoing, the embodiments of this invention use the advantage of information transportation between the thin client and the server and the large capacity of the hard disk on the server. The thin client of the embodiment may be deemed having many different environments to offer without physically increasing the size of the memory module.

Although the present invention has been described in considerable detail with reference t certain embodiments thereof, other embodiments are possible. Therefore, their spirit and scope of the appended claims should no be limited to the description of the embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A thin client-server architecture network, comprising:
a plurality of servers comprising a hard disk for storing a plurality of environmental parameters and a synchronizing application having information of the environmental parameters, wherein the environmental parameters stored in one of the servers are different from the environmental parameters stored in other servers; and
at least one thin client connecting one of the servers through the Internet and consisting essentially of a display, a memory module, an input module, a central processing unit, a synchronizing module, and a user interface electrically connected together, wherein the synchronizing module is operated for setting transport protocol with the synchronizing application, receiving the information of the environmental parameters and receiving part of the environmental parameters, wherein the environment of the user interface is changed according to the received part of the environmental parameters.

2. The thin client-server architecture network of claim 1, wherein the environmental parameters are environmental configurations of a first language.

3. The thin client-server architecture network of claim 4, wherein the configurations of the first language comprises a plurality of font data and at least an input method of the first language.

4. The thin client-server architecture network of claim 1, wherein the environmental parameters are a plurality of font characters of a font, a plurality of character coding of at least an input method, or a plurality of keyboard encoding of at least a keyboard mapping.

5. A method for using thin client-server architecture networks, comprising:
connecting a thin client to a server having a plurality of environmental parameters through the Internet;
setting transport protocol between the thin client and the server;
transmitting one of the environmental parameters from the server to the thin client; and changing the environment of a user interface of the thin client according to the received environmental parameter.

6. The using method of claim 5, wherein the environmental parameters are environmental configurations of a language.

7. The using method of claim 6, wherein the step of changing the environment of the user interface of the thin client comprising:
setting the environment of the user interface to be the first language environment.

8. The using method of claim 5, before the step of transmitting one of the environmental parameters further comprising:
transmitting a common signal from the thin client to the server base on the transport protocol, wherein a program of the server selects one of the environmental parameters according to the common signal.

9. The using method of claim 8, wherein the environmental parameters is a plurality of fonts, each font comprising a plurality of font characters, and wherein the program is an input method.

10. The using method of claim 8, wherein the environmental parameters comprise a plurality of font characters and a plurality of character coding corresponding to the font characters, and wherein the program is an input method.

11. The using method of claim 8, wherein the environmental parameters is a plurality of keyboard encoding, and wherein the program is a keyboard mapping.

12. A method for using thin client-server architecture networks, comprising:
setting an environment of a user interface of a thin client as a first environment configuration;
connecting the thin client to a server through the Internet, wherein the server has a plurality of environmental parameters;
setting transport protocol between the thin client and the server;
transmitting part of the environmental parameters from the server to the thin client;
using the received environmental parameters to form a second environment configuration on the thin client; and
changing the environment of the user interface from the first environment configuration to the second environment configuration.

13. The using method of claim 12, wherein the first environment configuration is for a first language, the second environment configuration is for a second language different from the first language.

14. The using method of claim 13, wherein the first environment configuration comprises a plurality of font data and at least an input method of the first language, and wherein the second environment configuration comprises a plurality of font data and at least an input method of the second language.

15. The using method of claim 12, wherein the environmental parameters are a plurality of font characters of a font, a plurality of character coding of at least an input method, or a plurality of keyboard encoding of at least a keyboard mapping.
